(19) United States
(12) Patent Application Publication
(10) Pub. No.: US 2016/0312121 A1
(43) Pub. Date: Oct. 27, 2016

(54) BROMINE-FREE FIRE RETARDANT (FR) AGENTS CAPABLE OF USING A CYCLIZATION MECHANISM

(71) Applicant: EMPIRE TECHNOLOGY DEVELOPMENT LLC, Wilmington, DE (US)

(72) Inventors: John Warner, Wilmington, MA (US); Pui-In Tang, Ypsilanti, MI (US); Amie Stewart, Reading, MA (US); Colleen Kelly, Brentwood, NH (US)

(21) Appl. No.: 15/026,915

(22) PCT Filed: Oct. 2, 2013
(86) PCT No.: PCT/US13/63113

§ 371 Date: Apr. 1, 2016

(51) Int. Cl. C09K 21/10; C08K 5/20; C08K 5/31; C08K 5/17

(52) U.S. Cl. CPC C09K 21/10; C08K 5/175; C08K 5/20; C08K 5/31; C08K 2201/019

(57) ABSTRACT

Provided herein are fire retardant compounds capable of undergoing a cyclization reaction to provide an elimination product and a cyclization product, as described herein. Also provided are compositions, polymers and articles including a fire retardant compound, and processes for preparing the compositions and articles.

### FIELD

The present technology relates generally to methods and compositions pertaining to flame retardants.

### BACKGROUND

The following description is provided to assist the understanding of the reader. None of the information provided or references cited is admitted to be prior art to the present technology.

Fire retardant (FR) agents are utilized to reduce the flammability of several components such as textiles and plastics. Halogenated compounds are the most commonly used class of FR agents. Brominated flame retardants, such as tetrabromobisphenol-A (TBBPA), hexabromocyclododecane (HBCD) and decabromodiphenyl ether (Deca-BDE) have long been favored for their performance and cost. However, halogenated FR agents have been found to be persistent organic pollutants which exhibit serious adverse health consequences such as adverse developmental, endocrine, thyroid, reproductive and neurological effects. The US Environmental Protection Agency (EPA), and several major manufacturers of flame retardants, have announced that they will progressively phase out Deca-BDE in the US by 2013. A safe alternative to brominated FR agents is, therefore, in demand.

There are five known mechanisms by which the FR agents act, namely endothermic degradation, dilution of fuel, thermal shielding, dilution of gas phase and gas phase radical quenching. In searching for alternatives to the halogenated FR agents, compounds which would operate as FR agents by utilizing one of these mechanisms are being explored. Recent advances in FR technology for polymeric materials have focused on polyorganosiloxanes, polymer-clay nanocompositions and boron containing compounds. However, there is increased need for improved, environmentally friendly FR agents which meet the regulatory requirements while satisfying the mandatory levels of fire-safety performance.

### SUMMARY

The present technology provides for flame retardant or fire retardant compositions and methods.

In an embodiment, a composition includes at least one polymer; and at least one fire retardant compound capable of undergoing a cyclization reaction to provide an elimination product and a cyclization product.

In an embodiment, a method of making a fire-retardant composition includes: combining at least one polymer and at least one fire retardant compound capable of undergoing a cyclization reaction to provide an elimination product and a cyclization product.

In an embodiment, a method of protecting an article from fire includes exposing an article to flame or heat, and wherein the article includes at least one polymer and at least one fire retardant compound capable of undergoing a cyclization reaction to provide an elimination product and a cyclization product.

The foregoing summary is illustrative only and is not intended to be in any way limiting. In addition to the illustrative aspects, embodiments and features described above, further aspects, embodiments and features will become apparent by reference to the following drawings and the detailed description.

### BRIEF DESCRIPTION OF THE FIGURES

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIGS. 1(A)-(C) show graphics depicting a flammability test procedure conducted on samples using a chemical exhaust hood, according to one embodiment.

FIG. 2 (A) is a bar graph showing a burn time of a control sample and test samples against average elapsed time in a chemical exhaust hood, according to one embodiment.

FIG. 2 (B) is a bar graph showing a burn time of a control sample and test samples against average elapsed time in a UL94 chamber, according to one embodiment.

### DETAILED DESCRIPTION

The illustrative embodiments described in the detailed description and claims are not meant to be limiting. Other embodiments may be utilized, and other changes may be made, without departing from the spirit or scope of the subject matter presented here.

The present technology is described herein using several definitions, as set forth throughout the specification.

As used herein, unless otherwise stated, the singular forms “a,” “an,” and “the” include plural reference. Thus, for example, a reference to “a cell” includes a plurality of cells, and a reference to “a molecule” is a reference to one or more molecules.

As used herein, the term “comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition or process consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention.

As used herein, “about” will be understood by persons of ordinary skill in the art and will vary to some extent depending upon the context in which it is used. The term “about” when used before a numerical designation, e.g., temperature, time, amount, and concentration, including range, indicates approximations which may vary by (+) or (−) 10%, 5% or 1%. If there are uses of the term which are not clear to persons of ordinary skill in the art, given the context in which it is used, “about” will mean up to plus or minus 10% of the particular term.

As used herein, the term “hydrocarbon” denotes aliphatic, alicyclic and aromatic groups having an all-carbon backbone and consisting of carbon and hydrogen atoms, except where otherwise stated. Examples of hydrocarbon groups include alkyl, cycloalkyl, cycloalkenyl, carbocyclic aryl, alkenyl, alkynyl, cycloalkylalkyl, cycloalkenylalkyl, and carbocyclic aralkyl, aralkenyl and aralkynyl groups. Such groups can be unsubstituted or substituted by one or more substituents as defined herein.

As used herein, Cₘ-Cₙ, such as C₁-C₁₀, C₁-C₆, or C₁-C₄, when used before a group refers to that group containing m to n carbon atoms.

As used herein, the term “alkyl” refers to monovalent saturated aliphatic hydrocarbyl groups having the specified number of carbon atoms. Where not specified, an alkyl includes from 1 to 24 carbon atoms (i.e., C₁-C₂₄). For example, alkyls may have 1, 2, 3, 4, 5, 6, 7, 8, 9, 10, 11, 12, 13, 14, 15, 16, 17, 18, 19, 20, 21, 22, 23 or 24 carbon atoms or ranges between and including any two of the foregoing values (e.g., C₁-C₁₀ alkyl, C₁-C₆ alkyl, C₁-C₄ alkyl, and the like). This term includes, by way of example, linear and branched hydrocarbyl groups such as methyl (CH₃—), ethyl (CH₃CH₂—), n-propyl (CH₃CH₂CH₂—), isopropyl ((CH₃)₂CH—), n-butyl (CH₃CH₂CH₂CH₂—), isobutyl ((CH₃)₂CHCH₂—), sec-butyl ((CH₃)(CH₃CH₂)CH—), t-butyl ((CH₃)₃C—), n-pentyl (CH₃CH₂CH₂CH₂CH₂—), and neopentyl ((CH₃)₃CCH₂—). Alkyl groups may optionally be substituted. Representative substituted alkyl groups may be mono-substituted or substituted more than once, such as, but not limited to, mono-, di- or tri-substituted with substituents such as those listed herein.

As used herein, the “alkenyl groups” include straight and branched chain alkyl groups as defined above, except that at least one double bond exists between two carbon atoms. Thus, alkenyl groups have from 2 to 24 carbon atoms. For example, alkenyls may have 2, 3, 4, 5, 6, 7, 8, 9, 10, 11, 12, 13, 14, 15, 16, 17, 18, 19, 20, 21, 22, 23 or 24 carbon atoms or ranges between and including any two of the foregoing values (e.g., C₂-C₁₀ alkenyl, C₂-C₆ alkenyl, C₂-C₄ alkenyl, and the like). Examples include, but are not limited to vinyl, allyl, —CH=CH(CH₃), —CH═C(CH₃)₂, —C(CH₃)=CH₂, —C(CH₃)=CH(CH₃), -C(CH₂CH₃)=CH₂, among others. Alkenyl groups may optionally be substituted. Representative substituted alkenyl groups may be mono-substituted or substituted more than once, such as, but not limited to, mono-, di- or tri-substituted with substituents such as those listed herein.

As used herein, the terms “alkylene,” “cycloalkylene,” and “alkenylene,” alone or as part of another substituent, refer to a divalent radical derived from an alkyl, cycloalkyl, or alkenyl group, respectively, as exemplified by —CH₂CH₂CH₂CH₂—. For alkylene, cycloalkylene, and alkenylene linking groups, no orientation of the linking group is implied.

As used herein, the term “aryl” refers to a monovalent, aromatic mono- or bicyclic ring having 6-10 ring carbon atoms. Examples of aryl groups include phenyl and naphthyl. Aryl groups may be substituted. Representative substituted aryl groups include mono-, di-, tri-, tetra- and penta- substituted aryls with substituents such as those listed herein.

As used herein, the term “cycloalkyl” refers to a monovalent, hydrocarbyl mono-, bi-, or tricyclic ring having 3-12 ring carbon atoms. The cycloalkyl group may be a saturated hydrocarbyl mono-, bi-, or tricyclic ring. The cycloalkyl group may also include rings containing 1-2 carbon-carbon double bonds. Non-limiting examples of cycloalkyl groups include cyclopropyl, cyclobutyl, cyclopentyl, cyclohexyl, cycloheptyl, adamentyl, and the like. Cycloalkyl groups may be substituted in the same way that alkyl groups may be substituted.

As used herein, the term “halide,” “halo,” or “halogen” refers to fluorine, chlorine, bromine and iodine.

As used herein, the term “hydroxyl” refers to —OH. The term “alcohol” refers to a hydroxyl moiety which is bound to a carbon atom.

As used herein, the term “thiol” refers to —SH.

As used herein, the term “sulfide” refers to —S—S—.

As used herein, the term “carbonyl” refers to C═O.

As used herein, the term “ester” refers to a functional group composed of a carbon atom bonded to an oxygen atom, or a carbon atom double-bonded to an oxygen atom. Esters, as used herein, can have the chemical formula —(C═O)—O— or —O— (C═O)—.

As used herein, the term “carboxyl” refers to —COOH. The term “carboxylate” refers to —COO⁻.

As used herein, the term “amide” refers to —NR—(C═O)—, where R can be hydrogen or alkyl.

As used herein, the term “urea” refers to a functional group —NR(CO)NR—, where R can be hydrogen or alkyl.

As used herein, the term “ether” refers to a functional group having an oxygen atom bonded to two carbon atoms (—C—O—C).

As used herein, the term “amine” (or “amino”), as used herein, refers to —NHR or —NRR′ groups, where R, and R′ are independently hydrogen, or a substituted or unsubstituted alkyl, alkenyl, alkynyl, cycloalkyl, aryl or aralkyl group as defined herein. Examples of amino groups include —NH₂, methylamino, dimethylamino, ethylamino, diethylamino, propylamino, isopropylamino, phenylamino, benzylamino, and the like.

As used herein, the term “alkoxy” refers to —O-alkyl.

As used herein, the term “salt” refers to an ionic compound formed between an acid and a base. When the compound provided herein contains an acidic functionality, salts of such compounds include, without limitation, alkali metal, alkaline earth metal, and ammonium salts. As used herein, ammonium salts include salts containing protonated nitrogen bases and alkylated nitrogen bases. Exemplary and non-limiting cations of the salts of compounds having the acidic functionality include Na, K, Rb, Cs, NH₄, Ca, Ba, imidazolium, and ammonium cations based on naturally occurring amino acids. When the compounds utilized herein contain a basic functionality, salts of such compounds include, without limitation, salts of organic acids, such as caroboxylic acids and sulfonic acids, and mineral acids, such as hydrogen halides, sulfuric acid, phosphoric acid, and the likes. Exemplary and non-limiting anions of the salts of compounds having the anionic functionality include oxalate, maleate, acetate, propionate, succinate, tartrate, chloride, sulfate, bisalfate, mono-, di-, and tribasic phosphate, mesylate, tosylate, and the like.

As used herein, “substituted” refers to a chemical group as described herein that further includes one or more substituents, such as lower alkyl (including substituted lower alkyl such as haloalkyl, hydroxyalkyl, aminoalkyl), aryl (including substituted aryl), acyl, halogen, hydroxy, amino, alkoxy, alkylamino, acylamino, thioamido, acyloxy, aryloxy, aryloxyalkyl, carboxy, thiol, sulfide, sulfonyl, oxo, both saturated and unsaturated cyclic hydrocarbons (e.g., cycloalkyl, cycloalkenyl) , cycloheteroalkyls, and the like. These groups may be attached to any carbon or substituent of the alkyl, alkenyl, alkynyl, aryl, cycloheteroalkyl, alkylene, alkenylene, alkynylene, arylene, or hetero moieties. Additionally, the substituents may be in pendent from, or integral to the carbon chain itself.

As used herein, the term “fire-retardant” encompasses “flame-retardant.”

The disclosed embodiments relate to fire retardant or flame retardant compositions. In an embodiment, the fire retardant compositions include fire-retardant polymer compositions.

In one embodiment, a composition includes at least one polymer and at least one fire retardant compound capable of undergoing a cyclization reaction to provide an elimination product and a cyclization product.

The compositions of the disclosed embodiments are environmentally friendly and safe compared to halogen and phosphorous containing fire-retardant compositions. In one embodiment, the fire retardant compound is halogen-free. In other embodiments, the fire retardant compound is phosphorous-free. In still other embodiments, the fire retardant compound is halogen-free and phosphorous-free.

Suitable fire-retardant compounds include compounds capable of undergoing a cyclization reaction to provide an elimination product and a cyclization product . In some embodiments, the fire retardant compound is a hydroxy-carboxylic acid, hydroxy ester, hydroxy-amide, hydoxy-amido-carboxylic acid, urea-carboxylic acid, urea-amino acid, urea-ester, amino-ester, amino-amide, amino acid, amino acid-amide, amino-amino acid, amino acid-ester, or a salt thereof

In some embodiments, the cyclization product includes a three- to twelve-member ring. In some embodiments, the cyclization includes a three- to seven-member ring. In some embodiments, the cyclization product includes a five-member ring or a six-member ring.

In another embodiment, the fire retardant compound includes a compound of

Formula (I), or a salt thereof:

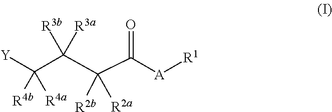

wherein:
A is O, O⁻, NH or NR⁵;
Y is (CH₂)₀₋₁OH, (CH₂)₀₋₁NH₂, (CH₂)₀₋₁NHR⁶, or (CH₂)₀₋₁NR⁶R⁷;
R¹ is H or a C₁-C₆ hydrocarbon group optionally substituted with OH, NH₂, carboxyl or a carboxylate; or, when A is O⁻, R¹ is a cation;
R^{2a}, R^{3a}and R^{4a} are each independently H, a C₁-C₆ hydrocarbon group, OH, or NH₂;
R^{2b}, R^{3b}, R^{4b}, R⁵, and R⁶ are each independently H or a C₁-C₆ hydrocarbon group; and
R⁷ is H, a C₁-C₆ hydrocarbon group, or C(═NH)NH₂.

In some embodiments, A is O and R¹ is H. In other embodiments, A is O⁻ and R¹ is a cation. In still other embodiments, A is NH and R¹ is an optionally substituted C₁-C₆ hydrocarbon group.

In some embodiments, R^{2a} is H, OH, or NH₂ and R^{2b} is H. In some embodiments, R^{3a} and R^{3b} are each independently an H or a C₁-C₆ hydrocarbon group. In some embodiments, both R^{3a} and R^{3b} are H. In other embodiments, both R^{3a} and R^{3b} are —CH₃. In some embodiments, R^{4a} and R^{4b} are each independently an H or a C₁-C₆ hydrocarbon group. In some embodiments, both R^{4a} and R^{4b} are H.

In some embodiments, Y is —OH. In other embodiments, Y is —(CH₂)—NH₂. In still other embodiments, Y is (CH₂)NR⁶R⁷; wherein R⁶ is H, and R⁷ is C(=NH)NH₂.

In another embodiment, the fire retardant compound is a compound of Formula (II), Formula (III), Formula (IV), or a salt thereof:

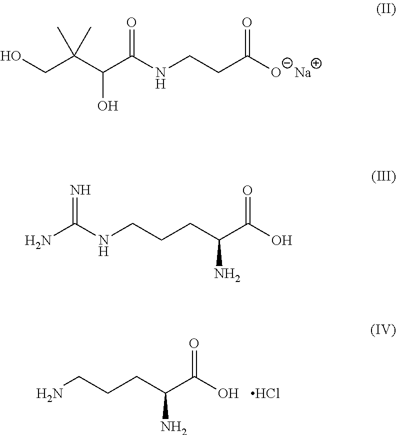

In some embodiments, the fire-retardant compound is selected from ornithine hydrochloride, sodium salt of pantothenic acid or arginine.

Suitable elimination products of the cyclization of the fire-retardant compound will be apparent to one skilled in the art. In some embodiments, the elimination product is at least one of H₂O, NH₃, ammonium ion, N₂, alcohol, amine, and an amine salt. In some embodiments, the elimination product is not a halogen or halide.

The fire retardant compounds are suitable for inclusion in a wide range of polymers including thermoplastic polymers, thermoset polymers, elastomeric polymers, and combinations thereof. In some embodiments, the polymer is a thermoset polymer or a thermoplastic polymer.

Suitable thermoplastic polymers include, but are not limited to, polyethylene(PE), polypropylene(PP), poly(butylene terephthalate) (PBT), poly(ethylene terephthalate) (PET), acrylonitrile-butadiene-styrene (ABS), polystyrene (PS), high impact polystyrene (HIPS), nylon, polybutadiene, polybutylene, polycarbonate (PC), cellulosic polymers, ethylene vinyl alcohol, liquid crystal polymer, phenolics, polyacetal, polyacrylates, polyacrylanitrile, polyamide, polyamide-imide, polyarylene ether, polyarylene ether-polyamide blends, polyaryletherketone, polychloroprene, polyester and unsaturated polyester, polyetheretherketone, polyetherimide, polyimide, polyphenylene oxide (PPO), polyphthalamide, polypropylene and polyethylene copolymers, polystyrene, polyurethane, polyvinylchloride (PVC), polyvinylidene chloride, thermoplastic elastomers and combinations of polymers. Suitable thermoset polymers include, but are not limited to, allyl resin, epoxy, melamine formaldehyde, phenol-formaldehyde plastic, polyester, polyimide, polyurethane, silicone and silicone rubber. Suitable elastomeric polymers include, but are not limited to, ethylene vinyl acetate, styrenic block copolymers, polyolefin blends, and elastomeric alloys.

In some embodiments, the one or more polymer included in the compositions of the disclosed embodiments is polyethylene, polypropylene, poly(butylene terephthalate) (PBT), poly(ethylene terephthalate) (PET), acrylonitrile-butadiene-styrene (ABS), high impact polystyrene (HIPS), or nylon. In some embodiments, the polymer included in the compositions of the disclosed embodiments is high impact polystyrene (HIPS). In some embodiments, the polymer is polyethylene.

Various types of polymers and copolymers can be utilized in the compositions of the disclosed embodiments. In some embodiments, the polymer is a blend, a block copolymer, a graft copolymer or a random copolymer. Exemplary blends include, but are not limited to, HIPS/PPO, PPO/PS, ABS/PC, PC/PS and the like. In other embodiments, the polymer may include aliphatic side chains which undergo cyclization.

The polymer and the fire-retardant compound are incorporated in the composition in an effective amount to achieve the desired fire retardant activity. The amount of polymer included in the composition can be varied to achieve the desired level of fire or flame retardancy. On a weight to weight percent basis, the composition may include one or more polymers in an amount of about 1 wt % to about 99 wt % of the total weight of the composition. In some embodiments, the composition may include one or more polymer in an amount of about 2 wt % to about 80 wt % of the total weight of the composition. In other embodiments, the composition may include one or more polymer in an amount of about 4 wt % to about 50 wt % of the total weight of the composition. In some embodiments, the composition may include one or more polymer in an amount of about 50 wt % to about 95 wt % of the total weight of the composition. In some embodiments, the composition may include one or more polymer in an amount of about 5% to about 45% by weight based on the total composition. Examples of the amount of one or more polymer in total wt % of the composition include about 1 wt %, about 2 wt %, about 5 wt %, about 10 wt %, about 20 wt %, about 30 wt %, about 40 wt %, about 50 wt %, about 60 wt %, about 70 wt %, about 75 wt %, about 80 wt %, about 85 wt %, about 90 wt %, about 95 wt%, about 96 Wt %, about 97 wt %, about 98 wt %, about 99 wt %, and ranges between and including any two of these values.

In some embodiments, the composition is a fire retardant. A fire retardant reduces flammability of fuels or delays their combustion. In one embodiment, the fire retardant compositions of the disclosed embodiments are substantially halogen-free. In other embodiments, the fire retardant compositions of the disclosed embodiments are substantially phosphorous-free. In still other embodiments, the fire retardant compositions of the disclosed embodiments are substantially halogen-free and phosphorous-free.

In some embodiments, compositions of the disclosed embodiments further include at least one filler, at least one additive, or both. Suitable fillers and additives useful in the present compositions will be apparent to one skilled in the art. Examples of the filler or additive include, but are not limited to, magnesium oxide, calcium oxide, aluminum oxide, manganese oxide, tin oxide, boehmite, dihydrotalcite, hydrocalumite, huntite, hydromagnesite, aluminum hydroxide, magnesium hydroxide, magnesium oxide, magnesium carbonate, calcium carbonate zirconium oxide, molybdenum oxide, bismuth oxide, talc, organoclay, glass fibers, marble dust, cement dust, feldspar, silica, ammonium bromide, antimony trioxide, antimony trioxide, zinc oxide, zinc borate, barium sulfate, silicones, aluminum silicate, calcium silicate, titanium oxide, or mixtures thereof

The compositions may further include, but are not limited to, paints, sealant, coatings, polymers, and the like. Such compositions include a polypeptide and at least one excipient, i.e., additive for the treatment of a cellulosic material as will be known by those skilled in the art.

Examples of a suitable excipient for the treatment of a cellulosic material include, but are not limited to, an oil, drier, pigment, leveling agent, flatting agent, dispersing agent, flow control agent, ultraviolet (UV) absorber, plasticizer, solvent, stabilizer, antioxidant and a combination thereof. Specific examples of such excipients can also be found in Raw Materials Index, published by the National Paint & Coatings Association, 1500 R.I. Avenue, N.W., Washington, D.C. 20005.

Illustrative driers include, but are not limited to, various salts of cobalt, iron, manganese, cobalt, lead, manganese, calcium, zinc, zirconium, bismuth, lithium, aluminum, barium, cerium, vanadium, lanthanum, neodymium, iron, sodium, or potassium, or combinations thereof. The driers may include fatty acid salts, e.g., octoates or naphthenates, in an amount of about 0.005 wt. % to about 0.5 wt. % metal, based on the weight of the polypeptide. A description of metal driers, their functions, and methods for using them may be found in Handbook of Coatings Additives, pp. 496-506, ed. by L. J. Calbo, Marcel Dekker, New York, N.Y., 1987.

Where the composition includes a pigment, the pigments may be organic or inorganic, including those set forth by the Colour Index, 3d Ed., 2d Rev., 1982, published by the Society of Dyers and Colourists in association with the American Association of Textile Chemists and Colorists. Other examples of suitable pigments include, but are not limited to, titanium dioxide, barytes, clay, calcium carbonate, CI Pigment White 6 (titanium dioxide), CI Pigment Red 101 (red iron oxide), CI Pigment Yellow 42, CI Pigment Blue (copper phthalocyanines); CI Pigment Red 49:1 and CI Pigment Red 57:1. Colorants such as, for example, phthalocyanine blue, molybdate orange, or carbon black may be added to the formulation.

Where the composition includes a leveling agent, illustrative agents include, but are not limited to, silicones, fluorocarbons, cellulosics, extenders, plasticizers, and combinations thereof. Where the composition includes a flatting agent, illustrative agents include, but are not limited to, synthetic silica, and synthetic silicate.

Where the composition includes a dispersing agent, illustrative agents include, but are not limited to, sodium bis(tridecyl) sulfosuccinate, di(2-ethyl hexyl) sodium sulfosuccinate, sodium dihexylsulfosuccinate, sodium dicyclohexyl sulfosuccinate, diamyl sodium sulfosuccinate, sodium diisobutyl sulfosuccinate, disodium iso-decyl sulfosuccinate, disodium ethoxylated alcohol half ester of sulfosuccinic acid, disodium alkyl amido polyethoxy sulfosuccinate, tetra-sodium N-(1,2-dicarboxyethyl)-N-octadecyl sulfosuccinamate, disodium N-octasulfosuccinamate, and sulfated ethoxylated nonylphenol, 2-amino-2-methyl-l-propanol.

Where the composition includes a flow control agent, illustrative agents include, but are not limited to, polyaminoamide phosphate, high molecular weight carboxylic acid salts of polyamine amides, and alkylene amine salts of an unsaturated fatty acid. Further examples include, but are not limited to, polysiloxane copolymers, polyacrylate solution, cellulose esters, hydroxyethyl cellulose, hydroxypropyl cellulose, polyamide wax, polyolefin wax, hydroxypropyl methyl cellulose, and polyethylene oxide.

Where the composition includes an ultraviolet (UV) absorber, illustrative absorbers include, but are not limited to, substituted benzophenone, substituted benzotriazoles, hindered amines, and hindered benzoates, diethyl-3-acetyl4-hydroxy-benzyl-phosphonate, 4-dodecyloxy-2-hydroxy benzophenone, and resorcinol monobenzoate.

Where the composition includes a plasticizer, illustrative plasticizers include, but are not limited to, mono C₈-C₂₄ fatty acids, C₈-C₂₄ saturated fatty acids, and phthalate esters such as di-2-ethyl hexyl phthalate (DEHP), diisodecyl phthalate (DIDP), diisononyl phthalate (DINP), and benzylbutylphthalate (BBP).

Illustrative solvents for use in the compositions include both aqueous and non-aqueous solvent. For example, water and organic solvents may be used. Illustrative organic solvents include, but are not limited to, ethanol, n-propanol, isopropanol, n-butanol, sec-butanol, isobutanol, ethylene glycol, monobutyl ether, propylene glycol n-butyl ether, propylene glycol methyl ether, propylene glycol monopropyl ether, dipropylene glycol methyl ether, diethylene glycol monobutyl ether, methylene chloride (dichloromethane), 1,1,1-trichloroethane (methyl chloroform), 1,1,2-trichloro-1,2,2-trifluoroethane (CFC-113), trichlorofluoromethane (CFC-11), dichlorodifluoromethane (CFC-12), chlorodifluoromethane (HCFC-22), trifluoromethane (HFC-23), 1,2-dichloro-1,1,2,2-tetrafluoroethane (CFC-114), chloropentafluoroethane (CFC-115), 1,1,1-trifluoro 2,2-dichloroethane (HCFC-123), 1,1,1,2-tetrafluoroethane (HCFC-134a), 1,1-dichloro-1-fluoroethane (HCFC-141b), 1-chloro-1,1-difluoroethane (HCFC-142b), 2-chloro-1,1,1,2-tetrafluoroethane (HCFC-124), pentafluoroethane (HFC-125), 1,1,2,2-tetrafluoroethane (HFC-134), 1,1,1-trifluuoroethane (HFC-143a), 1,1-difluoroethane (HFC-152a), parachlorobenzotrifluoride (PCBTF), cyclic, branched, or linear completely methylated siloxanes, acetone, perchloroethylene (tetrachloroethylene), 3,3-dichloro-1,1,1,2,2-pentafluoropropane (HCFC-225ca), 1,3-dichloro-1,1,2,2,3-pentafluoropropane (HCFC-225cb), 1,1,1,2,3,4,4,5,5,5-decafluoropentane (HFC-43-10mee), difluoromethane (HFC-32), ethylfluoride (HFC-161), 1,1,1,3,3,3-hexafluoropropane (HFC-236fa), 1,1,2,2,3-pentafluoropropane (HFC-245ca), 1,1,2,3,3-pentafluoropropane (HFC-245ea), 1,1,1,2,3-pentafluoropropane (HFC-245eb), 1,1,1,3,3-pentafluoropropane (HFC-245fa), 1,1,1,2,3,3-hexafluoropropane (HFC-236ea), 1,1,1,3,3-pentafluorobutane (HFC-365-mfc), chlorofluoromethane (HCFC-31), 1-chloro-1-fluoroethane (HCFC-151a), 1,2-dichloro-1,1,2-trifluoroethane (HCFC-123a), 1,1,1,2,2,3,3,4,4-nonafluoro-4-methoxy-butane (C₄F₉OCH₃), 2-(difluoromethoxymethyl)-1,1,1,2,3,3,3-heptafluoropropane ((CF₃)₂CFCF₂OCH₃), and 1-ethoxy-1,1,2,2,3,3,4,4,4-nonafluorobutane.

The composition may include one or more stabilizers. In some embodiments, the one or more stabilizers include an antioxidant, a UV absorber, a heat stabilizer, a light stabilizer, or a combination of any two or more thereof. On a weight to weight percent basis, the composition may include one or more stabilizers in an amount of about 0.1 wt % to 99.0 wt %. This may include from about 1.0 wt % to about 10.0 wt %, or from about 10.0 wt % to about 20.0 wt %, or from about 20.0 wt % to about 40.0 wt %, or from about 40.0 wt % to about 60.0 wt %, or from about 60.0 wt % to about 80.0 wt %, or from about 80.0 wt % to about 99.0 wt %, and ranges between any two of these values.

Illustrative antioxidants include 2,6-di-tert-butyl-4-(4,6-bis(octylthio)-1,3,5-triazin-2-ylamino)phenol, N,N′-di-2-butyl-1,4-phenylene-diamine, stearyl-3-(3′,5′-di-tert-butyl-4-hydroxyphenyl) propionate, dioctadecyl 3,3′-thiodipropionate, and combinations of any two or more such antioxidants. Illustrative UV absorbers include 2-benzotriazol-2-yl-4,6-bis-(1,1-dimethyl-propyl)-phenol, 2-(4,6-diphenyl-[1,3,5]triazin-2-yl)-phenol, (2-hydroxy-4-octyloxy-phenyl)-phenyl-methanone, and combinations of any two or more such UV absorbers.

Illustrative light stabilizers include hindered amines such as 2,2,6,6-tetramethyl piperidine, bis (1,2,2,6,6-pentamethyl-4-piperidinyl) sebacate, poly[[6-[(1,1,3,3,-tetramethylbutyl)amino]-s-triazine-2,4-diyl][2,2,6,6-tetramethyl-4-piperidyl)imino]] hexamethylylene[(2,2,6,6-tetramethyl-4-piperidyl)imino]], and combinations of any two or more such light stabilizers. Illustrative heat stabilizers include butyl tin carboxylate, barium zinc, tris(2,4-ditert-butylphenyl) phosphate, and combinations of any two or more such heat stabilizers.

In one embodiment, a method of making a fire-retardant composition is provided. In some embodiments, the method includes combining at least one polymer and at least one fire retardant compound capable of undergoing a cyclization reaction to provide an elimination product and a cyclization product.

The polymer and the fire retardant compound may be combined using methods known in the art. In some embodiments, the polymer and the fire retardant compound are mixed, blended or compounded together. In other embodiments, the fire retardant compound may chemically react with the polymer.

Suitable polymer and fire-retardant compounds are as mentioned herein. In some embodiments, the one or more polymers in the composition have a melt temperature which is lower than the cyclization temperature of the fire-retardant compound. In some embodiments, the one or more polymers in the composition have a melt temperature which is higher than the cyclization temperature of the fire-retardant compound. In some embodiments, the one or more polymers have a melt temperature from about 100° C. to about 400° C., about 140° C. to about 300° C., about 180° C. to about 250° C. and about 200° C. to about 230° C. In some embodiments, the cyclization temperature of the fire-retardant compound is from about 100° C. to about 500° C., about 150° C. to about 400° C., about 200° C. to about 300° C. and about 220° C. to about 280° C.

In some embodiments, the fire retardant compound is a hydroxy-carboxylic acid, hydroxy ester, hydroxy-amide, hydoxy-amido-carboxylic acid, urea-carboxylic acid, urea-amino acid, urea-ester, amino-ester, amino-amide, amino acid, amino acid-amide, amino-amino acid, amino acid-ester, or a salt thereof.

In another embodiment, the fire retardant compound include a compound of Formula (I) as disclosed herein, or a salt thereof.

In another embodiment, the fire retardant compound is a compound of Formula (II), Formula (III) or Formula (IV) as disclosed herein, or a salt thereof.

In some embodiments, the method further includes heating the fire-retardant composition. In some embodiments, the fire-retardant composition is heated at a temperature near the polymer melt temperature. In some embodiments, the method further includes applying pressure to the composition. The heat and the pressure are suitably applied to mold the fire-retardant composition in to a desired shape.

In some embodiments, the method further includes extruding or molding the fire-retardant composition. In some embodiments, the polymer and the fire retardant compound are combined and placed into a mold and subjected to thermal processing, e.g., by heating near the polymer melt temperature. The mold can further be consolidated by applying pressure and shaped in to a desired pattern.

In some embodiments, the method further includes cooling the extruded or molded composition.

In one embodiment, a method of protecting an article from fire is provided. The method may include exposing an article to flame or heat wherein the article includes at least one polymer; and at least one fire retardant compound capable of undergoing a cyclization reaction to provide an elimination product and a cyclization product.

In some embodiments, the article can display improved fire and flame retardant characteristics compared to the same article not comprising the fire retardant compound. The article can also meet the national and local standards, requirements and regulations for fire safety and flame retardancy.

Without wishing to be bound by theory, it is believed that the FR agents of the disclosed embodiments work on the principle that certain chemical reactions, for example, cyclization reactions such as lactam/lactone generation, are known to be endothermic, i.e., they require heat energy in order to proceed. Additionally, the by-products of the cyclization reaction are typically non-combustible compounds which aid in diluting the combustible gas or fuel concentration. The overall flame-retardant effect is thus believed to be based on a combination of endothermic degradation and gas phase dilution mechanisms.

Various articles which use fire retardant compounds are known in the art. Examples of articles include, but are not limited to, components for automotive, appliances, electronics, toys, textiles, furniture, carpets, upholstery, mattresses, vehicles, airplanes, sheath, jacket, insulation, cables for electrical or optical transmission, circuit boards, electric motors, coatings, paints, sealants, electronic enclosures, and the like.

The disclosed embodiment, thus generally described, will be understood more readily by reference to the following Examples, which are provided by way of illustration and are not intended to be limiting of the disclosed embodiments.

### EXAMPLES

### Example 1

### Synthesis of test Articles Comprising Flame Retardant Compositions

Test articles were produced by uniformly mixing 5 grams of fire-retardant compound with 45 grams polymer powder to form a mixture. The mixture was spread into a uniform layer in a mold. The mixture in the mold was placed onto a heated plate of a press, which was heated to a temperature near the polymer melt temperature. The mold cover was placed on top of the mold, and the mixture was consolidated under pressure into a sheet. A control article (I) was prepared using 50 grams polyethylene and no additives. A control article (II) was prepared using 4 grams decabromodiphenyl ether (DecaDBE), 44 grams polyethylene and 2 grams antimony trioxide. Three test samples were prepared, the first test sample using 45 grams of polyethylene with 5 grams of ornithine hydrochloride, the second test sample using 45 grams of polyethylene with 5 grams of a sodium salt of pantothenic acid, and the third test sample using 45 grams of polyethylene with 5 grams of arginine. For control article (I) with only polyethylene and no flame retardant, thermal processing was carried out at 300° F. (149 ° C.) under 7 metric tons pressure.

### Example 2

### Testing of Flammability Characteristics

The flammability characteristics of various polymer/flame-retardant compounds test articles and control articles prepared in Example 1 were measured and results were compared. Two test procedures were used:

### Preliminary Flammability Test Procedure Using a Chemical Exhaust Hood:

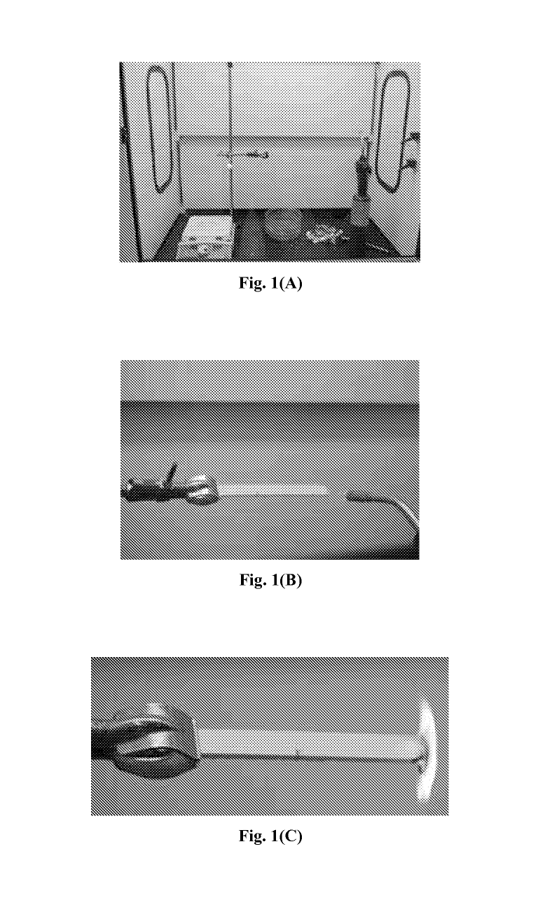

Samples of the test and control articles (about 125 mm long×about 13 mm wide×about 3 mm thick) were marked with lines at 25 mm and 100 mm from a first end of each sample to be ignited as shown in FIGS. 1(B) and 1(C). The samples were clamped at an opposite second non-marked end as shown in FIGS. 1(B) and 1(C), and placed in a chemical exhaust hood as shown in FIG. 1 (A). The samples were ignited using a propane torch as shown in FIG. 1 (B) at the first end. Samples were labeled “self extinguishing” if the flame went out after torching and the flame front does not reach the 25 mm mark, and for these samples, the distance from the first end to the extinguished point was measured and recorded. If the flame front reached the 25 mm mark, the time required to reach the 100 mm mark (actual burn distance was 75 mm) was measured and recorded. Test samples exhibiting 75 mm burn times less than that of pure polyethylene (Control (I)) were considered more flammable, while test samples with burn times exceeding the Control (I) were considered more flame retardant.

Flammability test procedure using the UL94 chamber:

Samples of the test and control articles (about 125 mm long×about 13 mm wide×about 3 mm thick) from Example 1 were marked with lines at 25 mm and 100 mm from a first end of each sample to be ignited. Sample flammability was measured according to the procedure provided in ASTM D635. The rate of burning and/or extent and time of burning of plastics in a horizontal direction was measured.

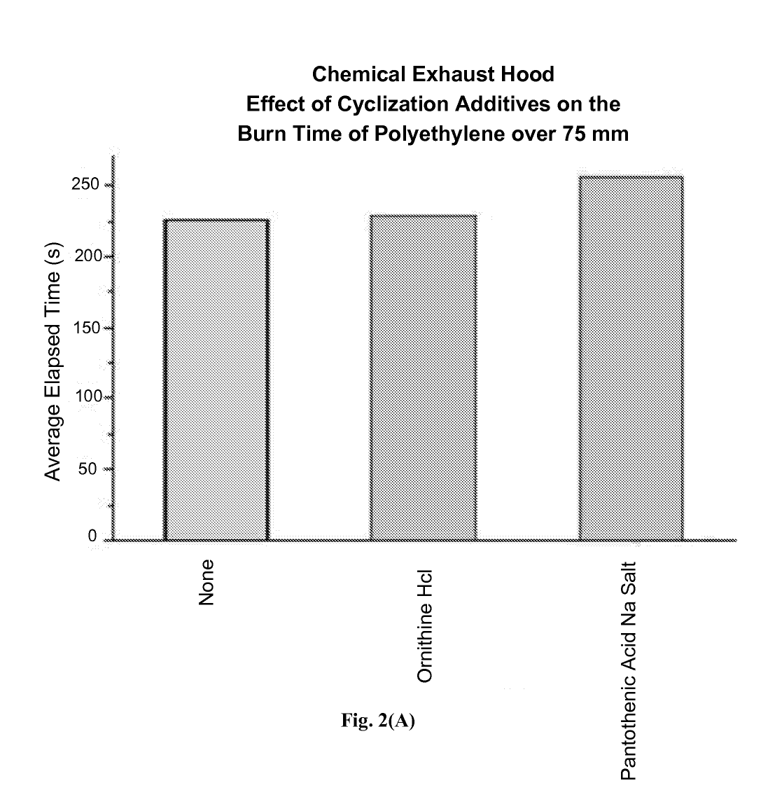

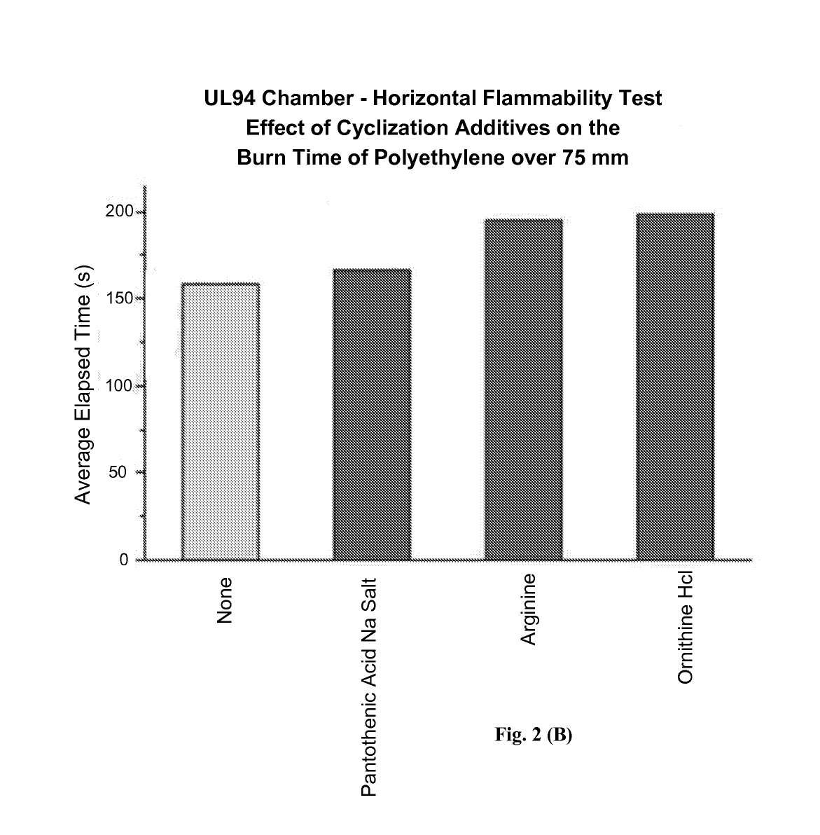

The flammability of the test and control articles was measured in both the chemical exhaust hood and UL94 chamber as described above. The data is summarized in FIGS. 2(A) and 2(B) and in the Table below.

| | Average elapsed | |
|---|---|---|
| | burn time for | Average elapsed |
| | PE over 75 mm | burn time for |
| | in Chemical | PE over 75 mm |
| Fire-retardant | Exhaust Hood | in UL94 Chamber |
| compound | (min) approx. | (min) approx. |
| None | 225 | 160 |
| Ornithine Hall | 230 | 200 |
| Pantothenic acid | 260 | 170 |
| Na salt | | |
| Arginine | — | 195 |

### Results:

As is evident from FIGS. 2(A) and 2(B), the test articles prepared from polyethylene and one of ornithine hydrochloride, sodium salt of pantothenic acid and arginine, exhibit improved flame retardant characteristics compared to the control articles having only the polymer and no fire retardant compound (Control (I)). It was observed that the 75 mm burn times of these test articles exceeded that of Control (I). It was also observed that Control article (II) failed to ignite. These results clearly demonstrate that compounds which can undergo a cyclization reaction to provide an elimination product and a cyclization product are effective fire retardants.

### Equivalents

The embodiments illustratively described herein may suitably be practiced in the absence of any element or elements, limitation or limitations, not specifically disclosed herein. Thus, for example, the terms “comprising,” “including,” “containing,” etc., shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than,” and the like, include the number recited and refer to ranges which can be subsequently broken down into subranges as discussed above. Similarly, the phrase “at least about” some value such as, e.g., wt %, includes at least the value and about the value. For example, “at least about 1 wt %” means “at least 1 wt % or about 1 wt%.” Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

1. A composition comprising at least one polymer; and
at least one fire retardant compound capable of undergoing a cyclization reaction to provide an elimination product and a cyclization product.

2. The composition of claim 1, wherein the polymer is a thermoset polymer or a thermoplastic polymer.

3. The composition of claim 1, wherein the fire retardant compound is halogen-free and phosphorous-free.

4. The composition of claim 1, wherein the fire retardant compound is a hydroxy-carboxylic acid, hydroxy ester, hydroxy-amide, hydoxy-amido-carboxylic acid, urea-carboxylic acid, urea-amino acid, urea-ester, amino-ester, amino-amide, amino acid, amino acid-amide, amino-amino acid, amino acid-ester, or a salt thereof.

5. The composition of claim 1, wherein the cyclization product comprises a five-member ring or a six-member ring.

6. The composition of claim 1, wherein the fire retardant compound is a compound of Formula (I): 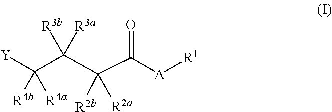
or a salt thereof, wherein:
A is O, O⁻, NH or NR⁵;
Y is (CH₂)₀₋₁OH, (CH₂)_{0.1}NH₂, (CH₂)₀₋₁NHR⁶, or (CH₂)₀₋₁NR⁶R⁷;
R¹ is H or a C₁-C₆ hydrocarbon group optionally substituted with OH, NH₂, carboxyl or a carboxylate; or, when A is O⁻, R¹ is a cation;
R^{2a}, R^{3a}, and R^{4a} are each independently H, a C₁-C₆ hydrocarbon group, OH, or NH₂;
R^{2b}, R^{3b}, R^{4b}, R⁵, and R⁶ are each independently H or a C₁-C₆ hydrocarbon group; and
R⁷ is H, a C₁-C₆ hydrocarbon group, or C(═NH)NH₂.

7. The composition of claim 5, wherein the fire retardant compound is:

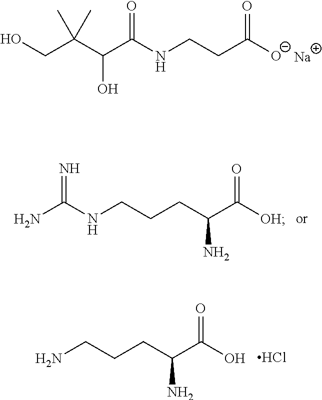

8. The composition of claim 1, wherein the elimination product is not a halogen or halide.

9. The composition of claim 1, wherein the elimination product is at least one of H₂O, NH₃, ammonium ion, N₂, alcohol, amine, and an amine salt.

10. The composition of claim 1, wherein one or more polymer is present in a concentration of about 5% to about 45% by weight based on the total composition.

11. The composition of claim 1, wherein the polymer is polyethylene (PE), polypropylene (PP), poly(butylene terephthalate) (PBT), poly(ethylene terephthalate) (PET), acrylonitrile-butadiene-styrene (ABS), high impact polystyrene (HIPS), or nylon.

12. The composition of claim 1, wherein the polymer is high impact polystyrene (HIPS).

13. The composition of claim 1, further comprising at least one filler, at least one additive, or both.

14. (canceled)

15. A method of making a fire-retardant composition, the method comprising:
combining at least one polymer and at least one fire retardant compound capable of undergoing a cyclization reaction to provide an elimination product and a cyclization product.

16. The method of claim 15, wherein the fire retardant compound is a hydroxy-carboxylic acid, hydroxy ester, hydroxy-amide, hydoxy-amido-carboxylic acid, urea-carboxylic acid, urea-amino acid, urea-ester, amino-ester, amino-amide, amino acid, amino acid-amide, amino-amino acid, amino acid-ester, or a salt thereof

17. (canceled)

18. The method of claim 16, wherein the fire retardant compound is a compound of Formula (II), Formula (III) or Formula (IV):

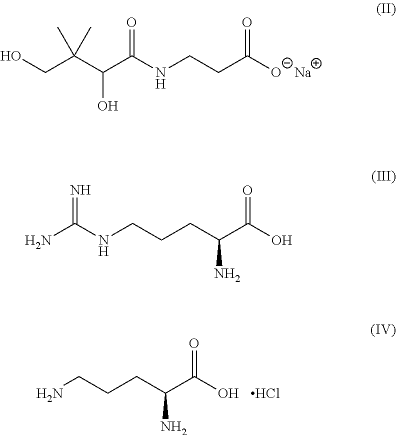

19. The method of claim 15, further comprising:
heating the fire-retardant composition
extruding or molding the fire-retardant composition; and
cooling the extruded or molded composition.

20. (canceled)

21. (canceled)

22. A method of protecting an article from fire, the method comprising:
exposing an article comprising:
at least one polymer; and
at least one fire retardant compound capable of undergoing a cyclization reaction to provide an elimination product and a cyclization product,
to flame or heat.

23. The method of claim 22, wherein the article displays improved fire and flame retardant characteristics compared to the same article not comprising the fire retardant compound.

24. The method of claim 22, wherein the article is an automotive, appliance, electric, electronic, toy, textile, carpet, upholstery, vehicle, or airplane, component.
